(19) United States
(12) Patent Application Publication
(10) Pub. No.: US 2011/0293870 A1
(43) Pub. Date: Dec. 1, 2011

(54) COMPOSITE COVER SHEET AND COVER SHEET ASSEMBLY

(76) Inventors: Ming-Chuan LIN, Tai Chung City (TW); Ping-Wen Huang, Tai Chung City (TW); Shih-Cheng Wang, Chang Hua County (TW); Chin-Liang Chen, Kao Hsiung City (TW); Hsien-Ming Wu, Tai Chung City (TW); Chen-Anne Chuang, Tai Chung County (TW); Chien-Wen Chen, Tai Chung County (TW); Hui-Chin Chen, Yun Lin County (TW); Han-Chung Chen, Tai Chung County (TW)

(21) Appl. No.: 13/113,557

(22) Filed: May 23, 2011

(30) Foreign Application Priority Data
May 26, 2010 (TW) 099116759

(51) Int. Cl. B32B 33/00

(52) U.S. Cl. 428/41.8; 428/42.2; 428/42.1

(57) ABSTRACT

A composite cover sheet includes a first protective film, a first adhesive layer, a second protective film and a second adhesive layer. The first protective film has a first sticking part and a first movable part. The first protective film is attached to a base sheet through the first adhesive layer, and the first protective film is removed from the base sheet through the first movable part. The second protective film has a second sticking part and a second movable part, and the second protective film and the first protective film are separately formed. The second protective film is attached to the first protective film through the second adhesive layer, and the second protective film is removed from the first protective film through the second movable part.

### BACKGROUND OF THE INVENTION

a. Field of the Invention

The invention relates to a composite cover sheet and a cover sheet assembly.

b. Description of the Related Art

Typically, a protective film is used to cover a screen of an electronic device for protection purposes. In the processes of assembling an electronic device, an upstream screen supplier uses a protective film to cover the screen for protecting the screen shipment. Then, a downstream assembly maker removes, after necessary assembly operations are preformed, the protective film from the screen and sticks a new protective film on the screen of an assembled electronic device. When the assembled electronic device is shipped to an end user, the user may manually remove the new protective film and start using the electronic device.

However, since a screen supplier and an assembly maker respectively prepare their own single protective film, an original protective film must be taken away and replaced with a new one for an end user. This greatly complicates assembly processes and results in considerable working hours. Also, the replacement of protective films is liable to dirty or scrape a screen.

### BRIEF SUMMARY OF THE INVENTION

The invention provides a composite cover sheet and a cover sheet assembly capable of overcoming disadvantages of aforesaid conventional designs.

In order to achieve one or a portion of or all of the objects or other objects, one embodiment of the invention provides a composite cover sheet that includes a first protective film, a first adhesive layer, a second protective film and a second adhesive layer. The first protective film has a first sticking part and a first movable part, and the first adhesive layer spreads on at least a partial region of the first sticking part. The first protective film is attached to a base sheet through the first adhesive layer, and the first protective film is removed from the base sheet through the first movable part. The second protective film has a second sticking part and a second movable part, and the second protective film and the first protective film are separately formed. The second adhesive layer spreads on at least a partial region of the second sticking part, the second protective film is attached to the first protective film through the second adhesive layer, and the second protective film is removed from the first protective film through the second movable part.

Another embodiment of the invention provides a cover sheet assembly including a base sheet and a composite cover sheet formed on the base sheet. The cover sheet assembly may be a release film or a part of a display panel, a touch panel or a portable device.

In one embodiment, the first movable part and the first sticking part are integrally formed as one piece, and the second movable part and the second sticking part are integrally formed as one piece. In one embodiment, the first movable part is a cutoff formed on the first protective film, and the second movable part is a cutoff formed on the second protective film.

In one embodiment, the first adhesive layer is made of acrylate or silicone, and the second adhesive layer is made of acrylate or silicone.

In one embodiment, the base sheet is made of polyethylene terephthalate (PET), polypropylene (PP) or polyethylene (PE).

In one embodiment, an area of the first protective film is smaller than an area of the second protective film.

In one embodiment, the composite cover sheet further includes a first marking layer formed on the first movable part of the first protective film and a second marking layer formed on the second movable part of the second protective film. The second marking layer and the first marking layer are different in color or shape to provide identification effects.

According to the above embodiments, an integral arrangement of the first protective film and the second protective film provides full protection at different operational phases of product assembly and shipment. An assembly maker may simply remove an upper protective film of a composite cover sheet rather than stick a new protective film to replace the original protective film prepared by an upstream screen supplier. This effectively simplifies assembly processes, reduces working hours, and prevents a screen from being dirtied or scrapped during the replacement of protective films. Besides, the movable parts may facilitate the operations of attaching and removing a protective film.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B show schematic diagrams of a cover sheet assembly according to an embodiment of the invention.

FIG. 2A and FIG. 2B show schematic diagrams of a cover sheet assembly according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

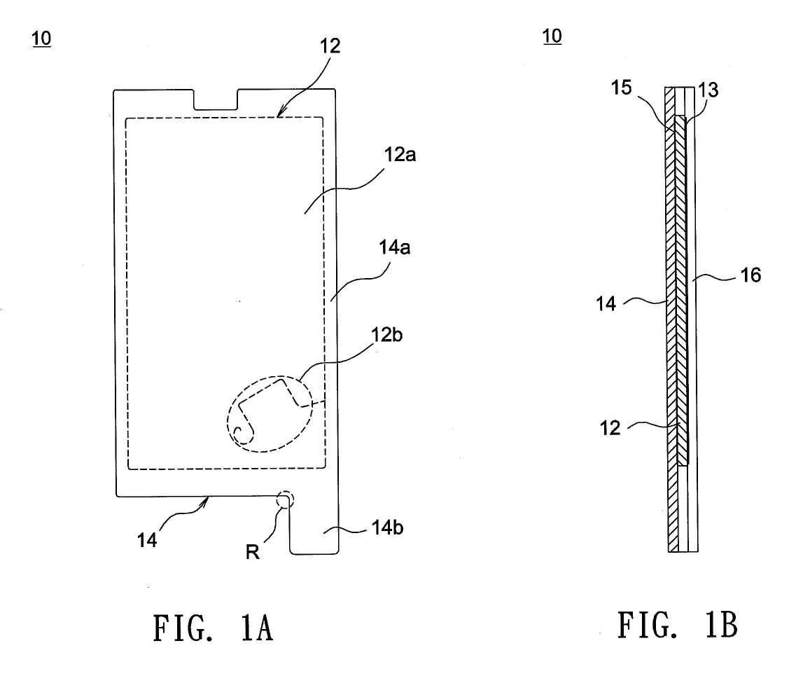

FIG. 1A and FIG. 1B show schematic diagrams of a cover sheet assembly according to an embodiment of the invention. The cover sheet assembly 10 includes a base sheet 16 and a composite cover sheet formed on the base sheet 16. The composite cover sheet includes a first protective film 12 and a second protective film 14 stacked with each other. The first protective film 12 and the second protective film 14 are separately formed and are different in shape and area. For example, an area of the first protective film 12 is smaller than an area of the second protective film 14. Referring to FIG. 1A and FIG. 1B, in this embodiment, the first protective film 12 may have a first sticking part 12a and a first movable part 12b. A first adhesive layer 13 spreads on at least a partial region of the first sticking part 12a, and the first protective film 12 is attached to a base sheet 16 through the first adhesive layer 13. The second protective film 14 may have a second sticking part 14a and a second movable part 14b. A second adhesive layer 15 spreads on at least a partial region of the second sticking part 14a, and the second protective film 14 is attached to the first protective film 12 through the second adhesive layer 15. The first sticking part 12a and the second sticking part 14a serve a function of surface protection, and the first movable part 12b may be formed at a position not overlapping with the second movable part 14b. Each of the movable parts 12b and 14b may function as a handhold. Therefore, one may grab the first movable part 12b by his fingers to easily remove the first protective film 12, and one may grab the second movable part 14b to easily remove the second protective film 14. Besides, a connection side edge, for example, between the second movable part 14b and the second sticking part 14a may be provided with a round corner R to smooth the removing and attaching operations.

The first protective film 12 and the second protective film 14 are attached to the base sheet 16 (such as a screen of an electronic device) respectively. Hence, an upstream screen supplier may provide at least two protective films formed on a base sheet 16, and a downstream assembly maker may remove the second protective film 14 after necessary assembly operations are preformed. Therefore, the second protective film 14 is allowed to protect the base sheet 16 of an electronic device (such as a display or a touch panel) from being damaged. Then, when the assembled electronic device is shipped to an end user, the user manually removes the first protective film 12 and starts using the electronic device. According to the above embodiment, an integral arrangement of the first protective film 12 and the second protective film 14 provides full protection at different operational phases of product assembly and shipment. An assembly maker may simply remove an upper protective film of a composite cover sheet rather than stick a new protective film to replace the original protective film prepared by an upstream screen supplier. This effectively simplifies assembly processes, reduces working hours, and prevents a screen from being dirtied or scrapped during the replacement of protective films. Besides, the movable parts 12b and 14b may facilitate the operations of attaching and removing a protective film.

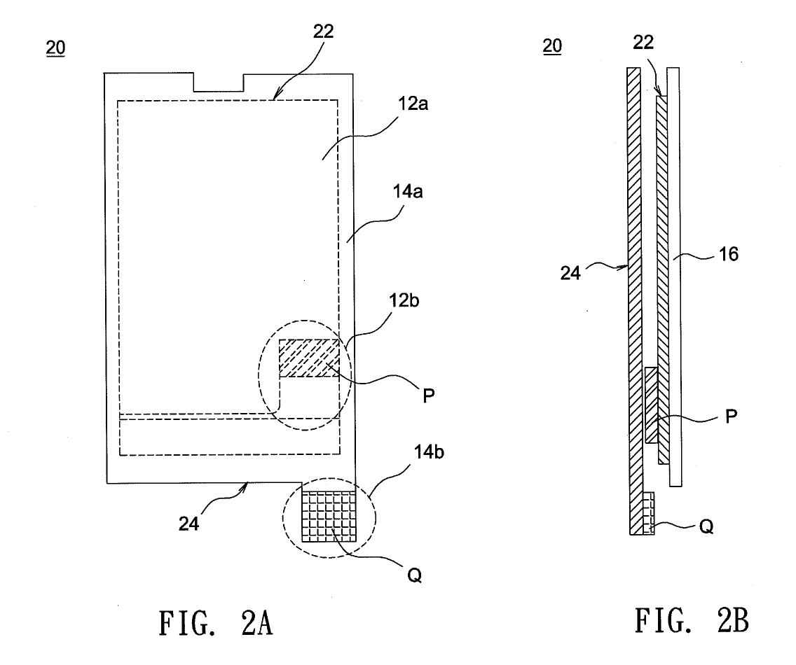

FIG. 2A and FIG. 2B show schematic diagrams of a cover sheet assembly 20 according to another embodiment of the invention. Referring to FIG. 2A and FIG. 2B, the cover sheet assembly 20 includes a base sheet 16 and a first protective film 22 and a second protective film 24 stacked with each other. The first protective film 22 and the second protective film 24 are separately formed and are different in shape and area. The configuration of the first protective film 22 and the second protective film 24 is similar to the above embodiment, thus not describing in detail. In this embodiment, a marking layer P is formed on the first movable part 12b of the first protective film 22, and a marking layer Q is formed on the second movable part 14b of the second protective film 24. The marking layer P and marking layer Q may be distinguished by, for example, distinct colors or distinct shapes, so that one can easily identify a target protective film to be removed to ensure production yields.

Further, in the above embodiments, the shape and the forming method of each movable part that functions as a handhold are not limited. For example, a protective film may be cut to directly form a movable part (movable part 14b and sticking part 14a shown in FIG. 1A are integrally formed as one piece). Alternatively, a cutoff may be formed on a protective film (moveable part 12b shown in FIG. 1A), or a segment of tape is attached to a protective film (movable part 12b shown in FIG. 2A). In addition, the composite cover sheet is not limited to have two layers. The composite cover sheet may have there layers or more according to actual demands.

Note the base sheet 16 according to the above embodiments is not limited to a specific element. For example, the base sheet 16 may be a separate element like a release film. The composite cover sheet may be disposed on a release film for transportation purposes to perform all types of processes. Alternatively, the base sheet 16 may be a part of an electronic device like a display panel, a touch panel, a portable device, etc. Further, in one embodiment, each movable part may be formed on the periphery of a protective film to allow the protective film to be stably attached or assembled to any object. Certainly, the movable part is not limited to the shape of a handhold. In one embodiment, the material of the adhesive layer may be acrylate or silicone, and the base sheet may be made of polyethylene terephthalate (PET), polypropylene (PP) or polyethylene (PE).

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding elements. These terms are not used to set up the upper limit or lower limit of the number of bumps.

What is claimed is:

1. A composite cover sheet, comprising:
a first protective film having a first sticking part and a first movable part;
a first adhesive layer spreads on at least a partial region of the first sticking part, wherein the first protective film is attached to a base sheet through the first adhesive layer, and the first protective film is removed from the base sheet through the first movable part;
a second protective film having a second sticking part and a second movable part, wherein the second protective film and the first protective film are separately formed; and
a second adhesive layer spreads on at least a partial region of the second sticking part, wherein the second protective film is attached to the first protective film through the second adhesive layer, and the second protective film is removed from the first protective film through the second movable part.

2. The composite cover sheet as claimed in claim 1, wherein the first movable part and the first sticking part are integrally formed as one piece, and the second movable part and the second sticking part are integrally formed as one piece.

3. The composite cover sheet as claimed in claim 1, wherein the first movable part is a cutoff formed on the first protective film, and the second movable part is a cutoff formed on the second protective film.

4. The composite cover sheet as claimed in claim 1, wherein the first movable part is attached to the first protective film, and the second movable part is attached to the second protective film.

5. The composite cover sheet as claimed in claim 1, wherein the first adhesive layer is made of acrylate or silicone.

6. The composite cover sheet as claimed in claim 1, wherein the second adhesive layer is made of acrylate or silicone.

7. The composite cover sheet as claimed in claim 1, wherein the base sheet is made of polyethylene terephthalate (PET), polypropylene (PP) or polyethylene (PE).

8. The composite cover sheet as claimed in claim 1, wherein an area of the first protective film is smaller than an area of the second protective film.

9. The composite cover sheet as claimed in claim 1, wherein the first movable part of the first protective film is not overlapped with the second movable part of the second protective film.

10. The composite cover sheet as claimed in claim 1, further comprising:
a first marking layer formed on the first movable part of the first protective film; and
a second marking layer formed on the second movable part of the second protective film, wherein the second marking layer and the first marking layer are different in color or shape to provide identification effects.

11. A cover sheet assembly, comprising:
a base sheet;
a first protective film having a first sticking part and a first movable part;
a first adhesive layer spreads on at least a partial region of the first sticking part, wherein the first protective film is attached to the base sheet through the first adhesive layer, and the first protective film is removed from the base sheet through the first movable part;
a second protective film having a second sticking part and a second movable part, wherein the second protective film and the first protective film are separately formed; and
a second adhesive layer spreads on at least a partial region of the second sticking part, wherein the second protective film is attached to the first protective film through the second adhesive layer, and the second protective film is removed from the first protective film through the second movable part.

12. The cover sheet assembly as claimed in claim 11, wherein the base sheet is a release film.

13. The cover sheet assembly as claimed in claim 11, wherein the base sheet is a part of a display panel, a touch panel or a portable device.
